(19) United States
(12) Patent Application Publication
(10) Pub. No.: US 2014/0081816 A1
(43) Pub. Date: Mar. 20, 2014

(54) COLLABORATIVE FINANCIAL PLANNING

(71) Applicant: Vsevolod Kuznetsov, Sankt-Petersburg (RU)

(72) Inventor: Vsevolod Kuznetsov, Sankt-Petersburg (RU)

(73) Assignee: RAWLLIN INTERNATIONAL INC.

(21) Appl. No.: 13/623,696

(22) Filed: Sep. 20, 2012

(51) Int. Cl. G06Q 40/00

(52) U.S. Cl. 705/35

(57) ABSTRACT

Disclosed are electronic systems and techniques for implementing collaborative financial planning. An input component can receive a set of data related to a collaborative financial goal from one or more participating users and/or a set of data sources. A goal setting component can determine or infer a collaborative financial goal based on least in part on the received set of data. The collaborative financial goal can include a savings and/or investment objective, a set of participating users, a goal description, and/or a target completion date. A planning component can dynamically generate a plan to achieve the collaborative financial goal, and an execution component can execute the plan, monitor progress, and update the plan based on the progress.

### TECHNICAL FIELD

The subject application relates to electronic commerce, and, more particularly, to facilitating consumers of financial services in collaboratively developing and executing collaborative financial plans.

### BACKGROUND

Developing a plan to achieve a financial goal, and carrying out the plan can be challenging for a large number of consumers. Consumers may face distractions or setbacks that prevent them from achieving a goal, or circumstances that existed when a plan was developed may change over time. Moreover, consumers may not have sufficient knowledge to develop an efficient plan for more complicated goals. A common option that consumers may choose is using a line of credit, such as a credit card, and paying down the line of credit over time. However, consumers having little, or not credit history, may be unable to open or access a line of a credit for a particular financial goal. In addition, existing line of credits may be insufficient or inappropriate for some financial goals.

Additional difficulties arise when consumers attempt to coordinate a plan for a financial goal that involves multiple parties. Integrating different personalities, desires, and financial knowledge into a single cohesive plan, and ensuring that each of the parties understand and complete their respective duties with regard to the plan can be difficult. Also, practical considerations such as how or where to maintain funds of respective parties can present additional difficulties.

Moreover, personal relationships between parties involved in a collaborative financial plan may create discomfort and stress. For instance, family members may be uncomfortable discussing financial issues, such as pay rates or savings amounts. Similarly, some people, based on their personal relationships, may feel uncomfortable attempting to implement or submit to aspects of a plan, such as collecting funds, or disbursing funds without having some level of control or accountability regarding the disbursements.

The above-described deficiencies of common financial planning techniques are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

The following presents a simplified summary in order to provide a basic understanding of some aspects disclosed herein. This summary is not an extensive overview. It is intended to neither identify key or critical elements nor delineate the scope of the aspects disclosed. Its sole purpose is to present some concepts in a simplified form as a prelude to the more detailed description that is presented later.

Various embodiments for collaborative financial planning are contained herein. An exemplary system, includes a goal setting component configured to determine or infer a collaborative financial goal for a set of participating users, a planning component configured to generate a plan for the collaborative financial goal, and an execution component configured to execute the plan to achieve the collaborative financial goal.

In another non-limiting embodiment, an exemplary method is provided that includes receiving data relating to a collaborative financial goal for a set of users, determining or inferring a set of goal data for the collaborative financial goal based at least in part on the received data, generating a plan for the collaborative financial goal based at least in part on the set of goal data, and in response to the generating, executing the plan to achieve the collaborative financial goal.

In still another non-limiting embodiment, an exemplary computer readable storage medium is provided that includes receiving data relating to a collaborative financial goal for a set of users, determining or inferring a set of goal data for the collaborative financial goal based at least in part on the received data, generating a plan for the collaborative financial goal based at least in part on the set of goal data, and in response to the generating, executing the plan to achieve the collaborative financial goal.

### BRIEF DESCRIPTION OF DRAWINGS

FIG. 1 illustrates an example collaborative financial planning system in accordance with various aspects described herein;

FIG. 2 illustrates an example collaborative financial planning system in accordance with various aspects described herein;

FIG. 3 illustrates an example goal setting component in accordance with various aspects described herein;

FIG. 4 illustrates an example planning component in accordance with various aspects described herein;

FIG. 5 illustrates an example linking component in accordance with various aspects described herein;

FIG. 6 illustrates an example execution component in accordance with various aspects described herein;

FIG. 7 illustrates an example collaborative financial planning system in accordance with various aspects described herein;

FIG. 8 illustrates an example planning component in accordance with various aspects described herein;

FIG. 9 is an example goal setting pane in accordance with various aspects described herein;

FIG. 10 is an example plan selection pane in accordance with various aspects described herein;

FIG. 11 is an example potential plan update pane in accordance with various aspects described herein;

FIGS. 12-15 illustrate flow diagrams showing exemplary non-limiting implementations for collaborative financial planning in accordance with various aspects described herein;

FIG. 16 is a block diagram representing exemplary non-limiting networked environments in which various non-limiting embodiments described herein can be implemented; and

FIG. 17 is a block diagram representing an exemplary non-limiting computing system or operating environment in which one or more aspects of various non-limiting embodiments described herein can be implemented.

### DETAILED DESCRIPTION

Embodiments and examples are described below with reference to the drawings, wherein like reference numerals are used to refer to like elements throughout. In the following description, for purposes of explanation, numerous specific details in the form of examples are set forth in order to provide a thorough understanding of the various embodiments. It will be evident, however, that these specific details are not necessary to the practice of such embodiments. In other instances, well-known structures and devices are shown in block diagram form in order to facilitate description of the various embodiments.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, a local area network, a wide area network, etc. with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components. In an aspect, a component can emulate an electronic component via a virtual machine, e.g., within a cloud computing system.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

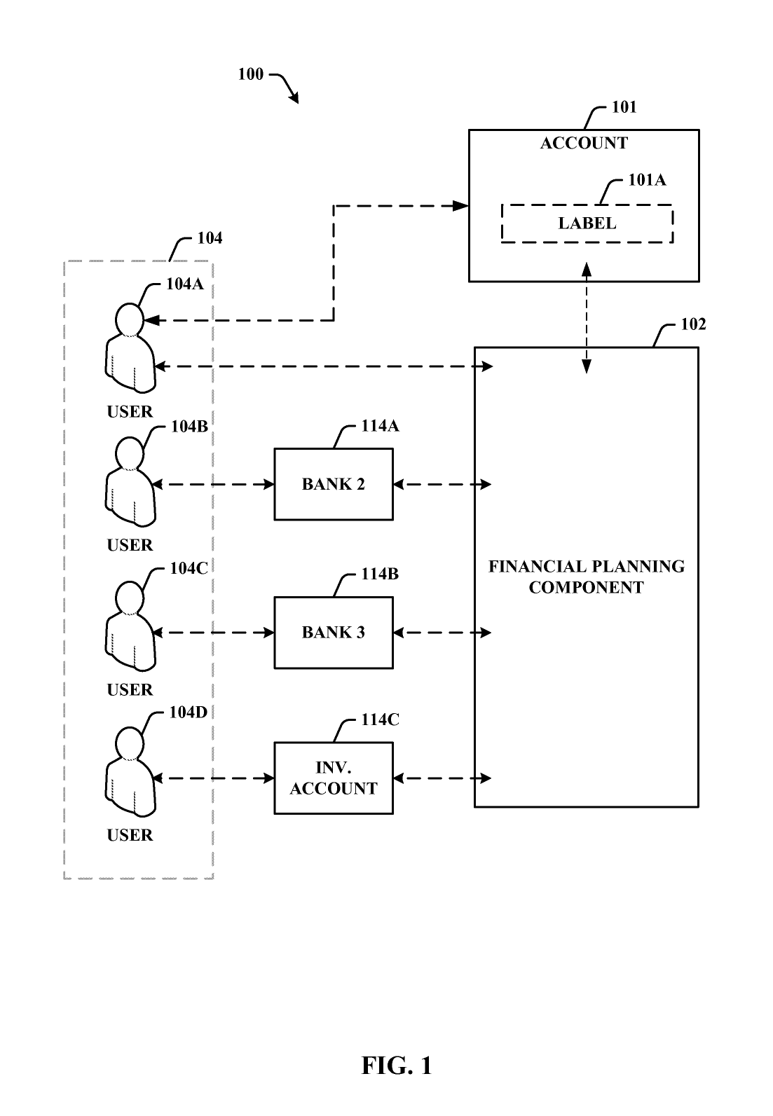

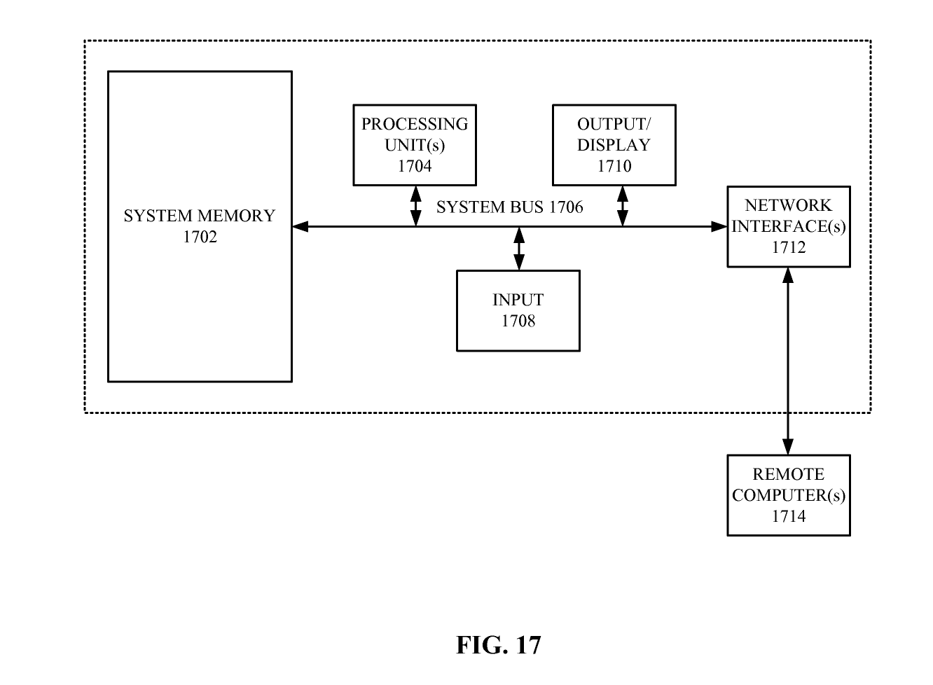

Referring initially to FIG. 1, illustrated is an example collaborative financial planning system 100 in accordance with various aspects described in this disclosure. Generally, system 100 can include a memory that stores computer executable components and a processor that executes computer executable components stored in the memory, examples of which can be found with reference to FIG. 17. System 100 includes a financial planning component 102. The financial planning component 102 allows a set of participating users 104 (participating users 104 or users 104) to determine, set, or otherwise generate a collaborative financial goal (goal). For example, the users 104 can generate a monetary savings goal (e.g., dollar amount) to achieve by a specified date using the financial planning component 102. In addition, the financial planning component 102 develops, determines, or otherwise generates a plan to achieve the goal, and implements, carries out, or otherwise executes the plan. The plan can include but is not limited to individual financial plans (e.g., budget, etc.) for respective users 104, contributions of respective users 104, and/or dates of contributions (contribution dates) of respective users 104. For instance, the financial planning component 102 can determine a second user 104B will contribute X dollars on a set of dates corresponding to a pay cycle of the second user 104B, where X is a real number greater than zero. It is to be appreciated that the invention is not limited by a quantity of participating users. For example, the set of participating users 104 can include Y users, where Y is an integer greater than zero.

In one embodiment, the financial planning component 102 can execute the plan or goal in part by enabling the application of labels to various portions of an account, e.g., application of a first label for a first portion of funds received or otherwise identified, or segmented in the account, and application of a second label for a second portion of funds received or otherwise identified, or segmented in the account. Thus, where a single account is used for all transactions, the financial planning component 102 can facilitate distinguishing the purpose of various portions of funds in the account with account labels that define how transactions can be applied to such portions of funds. For example, participants may utilize a joint account, or each have their own account and apply labels to portions of funds in the account, or respective accounts. For instance, funds can be labeled such that access to funds labeled for joint purposes as described herein may be conditioned by mutual agreement and/or be configured in the account settings, or respective account settings. Labels may be employed, for example, between a couple, where instead of each one of the couple having their separate accounts, they have joint account, but, by default or other agreement, each one has access only to the portion of funds deposited by each, obviating the need for separate accounts between them. Additionally, in order to designate mutual expenses, labels, with various rights rules for each participant, may be utilized.

In an alternate embodiment, based on labels, the financial planning component 102 can execute the plan in part by moving, reallocating, or otherwise transferring funds corresponding to determined contributions of respective users to an account 101 associated with the financial planning component 102. The account 101 can include but is not limited to a checking account, a savings account, an investment account (e.g., brokerage account, certificate of deposit, etc.), a creditor account (e.g., bill, account payable, etc.), and/or a retirement account. Additionally or alternatively, the financial planning component 102 can segregate, isolate, or otherwise apply a label 101A to a portion or segment of funds in the account 101 corresponding to the goal. For example, based on labels, the financial planning component 102 can transfer funds corresponding to determined contributions of respective users to the account 101, and apply the label 101A to the transferred funds.

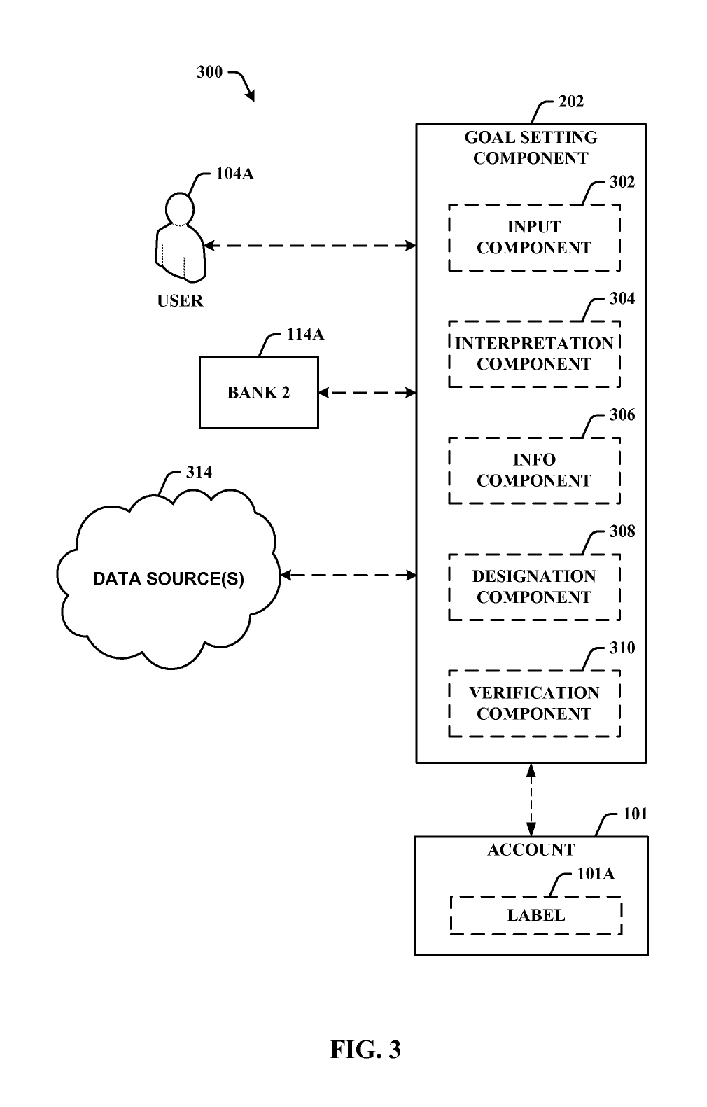

Access to funds having the label 101A can be limited, controlled, or otherwise restricted based on a set of access criteria. The access criteria can include but are not limited to permission from a subset of the users 104, occurrence of a predetermined event (e.g., goal satisfaction, etc.), an authorized expense, an emergency, and/or an authorized payee (discussed in greater detail with reference to FIG. 3). It is to be appreciated that although the account 101 and financial planning component 102 are illustrated as stand-alone components such implementation is not so limited. For example, the account 101 and/or financial planning component 102 can be included in and/or integrated with a banking system, a web portal, and/or an online shopping system.

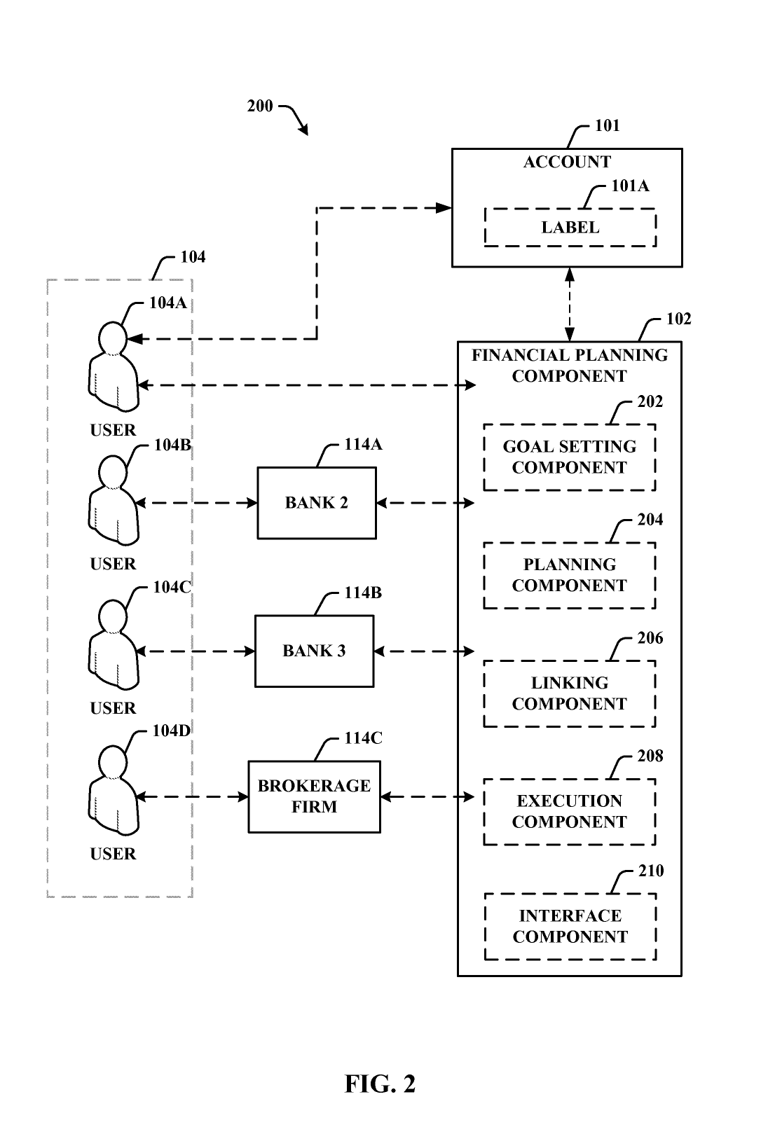

FIG. 2 illustrates an example collaborative financial planning system 200 in accordance with various aspects described in this disclosure. System 200 includes a financial planning component 102. As discussed previously, the financial planning component 102 provides for a set of participating users 104 (participating users 104 or users 104) to determine, set, or otherwise generate a collaborative financial goal (goal), generates a plan to achieve the goal, and executes the plan. The financial planning component 102 in FIG. 2 includes a goal setting component 202, a planning component 204, a linking component 206, an execution component 208, and an interface component 210.

The goal setting component 202 determines or infers a set of goal data for a collaborative financial plan. For example, the goal setting component 202 can receive data from a primary user (e.g., user 104A) associated with an account 101 and/or the financial planning component 102, and determine the set of goal data based at least in part on the set of received data. The set of goal data can include but is not limited to a savings and/or investment objective (goal amount), a set of participating users (e.g., participating users 104 or users 104), a goal reason and/or description (description), and/or a target completion date (target date). For example, the goal setting component 202 can receive data or inputs from the users 104 (e.g., participating users) regarding saving five thousand dollars (e.g., goal amount) for a family vacation (e.g., description) by the first of December (e.g., target date), and determine a subset of the goal data (e.g., participating users, goal amount, description, target date, etc.) based on the received data. As an additional or alternative example, the first user 104A can select an item they desire to purchase from an online catalog, and the goal setting component 202 can determine a subset of the goal data based on data (e.g., price, shipping cost, taxes, etc.) associated with the item from the online catalog (discussed in greater detail with reference to FIG. 3).

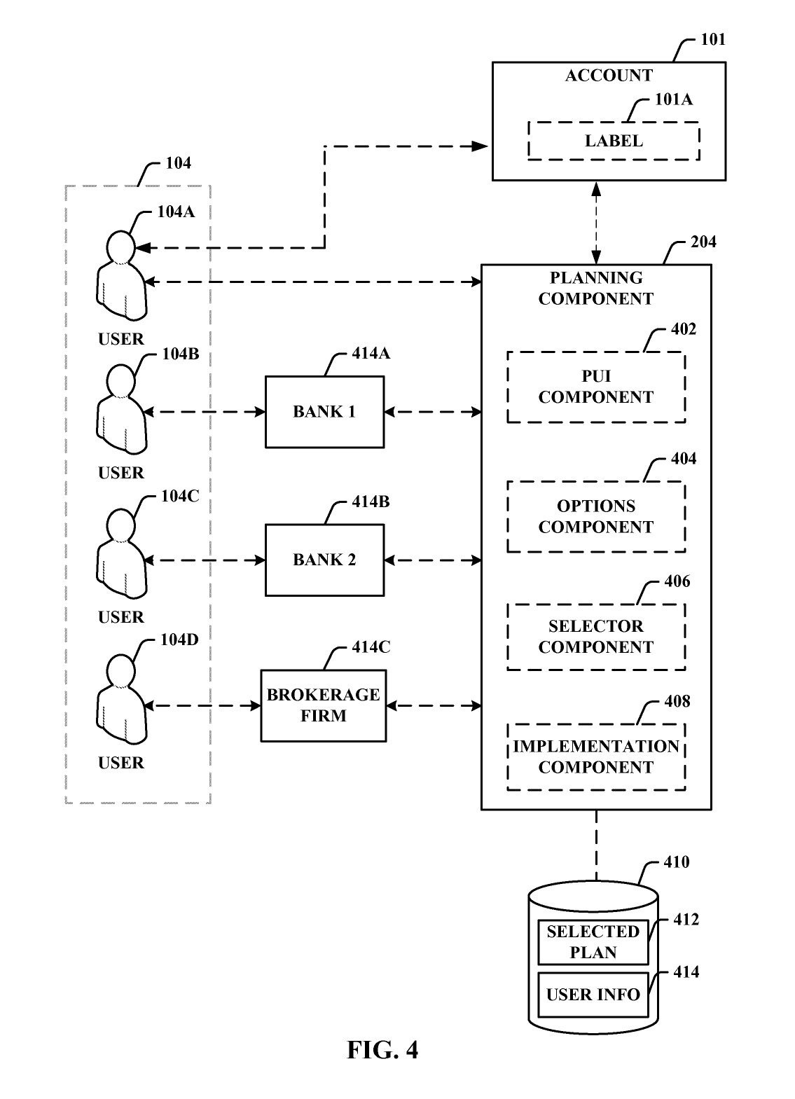

The planning component 204 establishes, creates, or otherwise generates a set of potential plans to achieve a goal based in part on the goal data (e.g., received using the goal setting component 202), and provides the set of potential plans to the users 104. For example, the planning component 204 can determine three potential plans to achieve a goal, and a subset of the users 104 can select one of the three potential plans to execute (selected plan). As an additional or alternative example, a subset of the participating users can adjust or modify a potential plan generated by the planning component 204, and select the modified plan (discussed in greater detail with reference to FIG. 4).

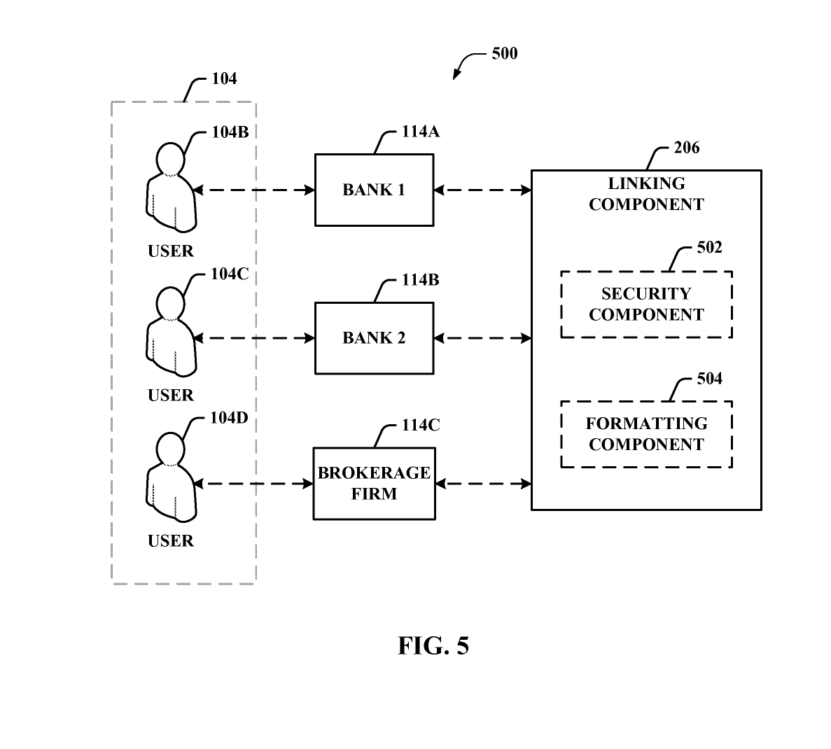

The linking component 206 associates, connects, or otherwise links different financial intuitions (e.g., banks, etc.) and/or accounts to the financial planning component 102. For example, a subset of the users 104 may have accounts that are not associated with the financial planning component 102 (unassociated accounts), and the linking component 206 can link the respective unassociated accounts to the financial planning component 102. For instance, a second user 104B can have a checking account with a second bank 114A, a third user 104C can have a savings account associated with a third bank 114B, and a fourth user 104D can have an investment account that is associated with a brokerage firm 114C. The linking component 206 can facilitate communications, transactions, and/or reporting with different financial institutions and/or accounts (discussed in greater detail with reference to FIG. 5).

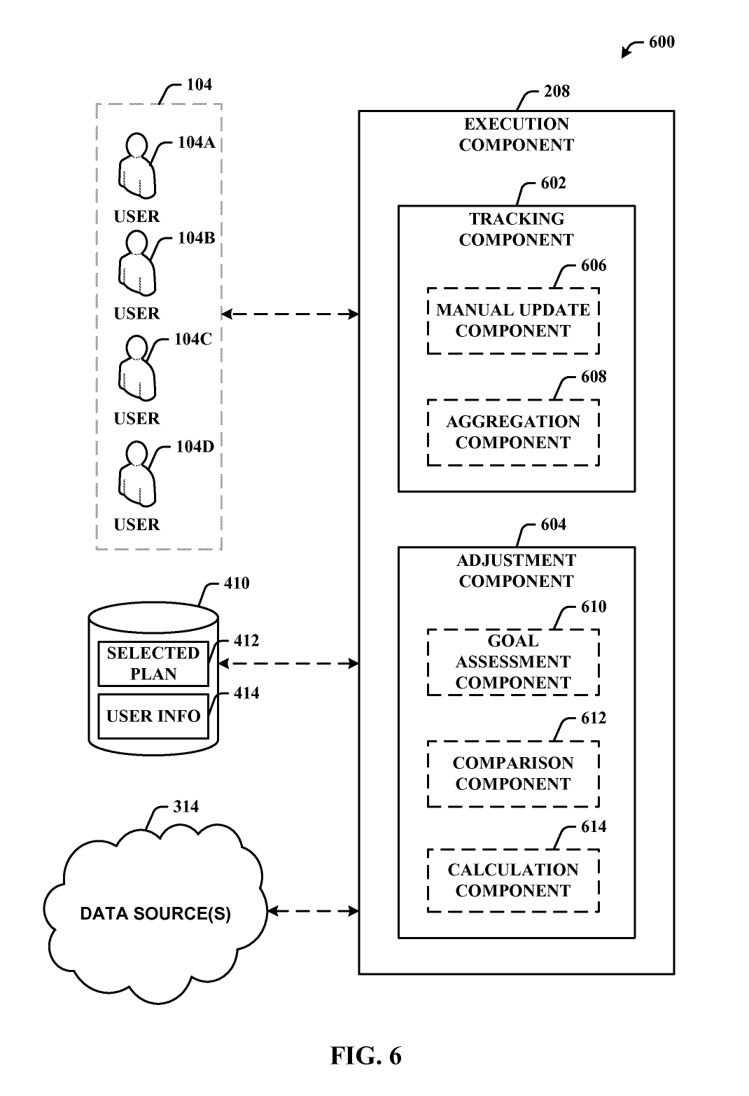

The execution component 208 implements, carries out, or otherwise executes a selected plan. For example, the execution component 208 can execute deposits, withdrawals, transfers, and/or payments (e.g., for accounts payable, etc.) based on the selected plan. For instance, based on the selected plan, the execution component 208 can facilitate automatic funds transfers, and/or provide reminders to participating users 104. Additionally, the execution component 208 analyses, tracks, or otherwise monitors progress with regard to the goal, and adjusts or updates the selected plan based on the progress (discussed in greater detail with reference to FIG. 6).

The interface component 210 includes any suitable and/or necessary adapters, connectors, channels, communication paths, etc. to integrate the financial planning component 102 into virtually any operating and/or database system(s). Moreover, the interface component 210 can provide various adapters, connectors, channels, communication paths, etc., that provide for interaction with the financial planning component 102. For example, the interface component 210 can enable the financial planning component 102 to communicate with unassociated financial institutions (e.g., bank 114A or bank 114B), websites, search engines, social networks, and/or shopping portals. It is to be appreciated that although the financial planning component 102 is illustrated as a stand-alone component, such implementation is not so limited. For example, the financial planning component 102 can be included in and/or associated with a banking system, web portal, shopping system, etc.

FIG. 3 illustrates an example goal setting component 202 in accordance with various aspects described in this disclosure. As discussed previously, the goal setting component 202 determines of infers a set of goal data related to a collaborative financial goal. The set of goal data can include but is not limited to a savings and/or investment objective (goal amount), a set of participating users (e.g., users 104), a goal reason and/or description (description), and/or a target completion date (target date). The goal setting component 202 in FIG. 3 includes an input component 302, an interpretation component 304, an information component 306 (info component 306), a designation component 308, and a verification component 310.

The input component 302 obtains, acquires, or otherwise receives inputs or data related to a set of goal data from a subset of the users 104 (e.g., a primary user or user 104A), an online catalog, a financial institution (e.g., bank 114A), a website, a search engine, a social network, and/or an account (e.g., bank, investment account, etc.) associated with one or more of the participating users 104. For example, in one embodiment, the input component 302 generates, manages, or otherwise controls a user interface, and/or application programming interface (API) to facilitate receiving the input. The input can include but is not limited to explicit user inputs (e.g., configuration selections, question/answer) such as from mouse selections, keyboard selections, speech, and so forth. For instance, the user 104A can provide a first subset of the goal data via selections included in a user interface (e.g., generated using the input component 302). As an additional or alternative example, in one embodiment, the input can include data uploads, wherein a data upload is a transfer of data from the user or a third party source (e.g. computer or a computer readable medium), to the input component 302. For instance, an online catalog (e.g., data source 314) and/or a bank (e.g., bank 114A) not associated with the financial planning component 102 can provide data related to the goal data to the input component 302 (e.g., via an API).

The interpretation component 304 determines or infers a first subset of goal data based in part on received input and/or data. For example, the interpretation component 304 can analyze human digestible data (e.g., plain language, phrases, etc.) provided by the user 104A, and determine, based in part on the analysis, the first subset of the goal data. For instance, the user 104A can input a phrase “My wife and I would like to save a down payment for a $250,000 house” (e.g., using the input component 302). The interpretation component 304 can analyze the phrase, and determine, for example, a set of participating users (e.g., user 104A and wife) and a description (e.g., house down payment). As an additional or alternative example, the interpretation component 24 can determine the first subset of goal data based on one or more items maintained in a wish list (e.g., favorites list, shopping cart, etc.). For instance, a first user (e.g., user 104A) can add an item (or service) to a wish list associated with a shopping portal (e.g., online catalog, etc.), and the interpretation component 304 can determine a set of participating users (e.g., the first user), and a savings objective (e.g., price of the item) based on the wish list item.

In another embodiment, a social networking platform, such as a personal social network that ties together only family and close friends, can be leveraged to input goals into the goal setting component 202. For instance, a family/close friends social network can be used by one member (e.g., son) of the family to publish a goal, such as “I want an iPhone5” and as part of that experience that ties into the goal setting component 202 to set up a financial goal (e.g., by interpretation component 304 or other interface tailored to handle goals from the personal social network), another member of the family (e.g., Dad) can set aside a portion of funds from his account that become available to the son upon meeting certain conditions, such as when the son saves and sets aside $100 towards the purchase price (presumably made from mowing the lawn or doing other chores on behalf of Dad). This kind of intimate financial planning experience is made possible through the personal social network, whereas someone might not want to publish such goals to a much broader audience or social network that does not tend to share financial goals with one another. Accordingly, a public or private interface can expose the financial planning platform described herein in various embodiments, to small pre-existing groups of interacting people via pre-existing applications.

The information component 306 (info component 306) obtains, acquires, or otherwise receives a second subset of goal data (e.g., supplemental information) related to the collaborative financial goal data from a set of data sources 314. The second subset of goal data can include but is not limited to a subset of goal data not included in the first subset of goal data, and/or different from (e.g., conflicting with) the first subset of goal data. Returning to a previous example, the info component 306 can receive a second subset of goal data for a mortgage that includes but is not limited to current or typical mortgage interest rates and/or down payment amounts (e.g., percentages) from one or more of financial institutions (e.g., data sources 314). The set of data sources 314 can include but are not limited to financial intuitions, websites, databases, social networks, search engines, and/or shopping portals (e.g., catalogs).

The designation component 308 provides for a user (e.g., user 104A) to select, determine, or otherwise designate an account (primary account) and/or label for maintaining funds related to a goal. For example, the user 104A can designate an account belonging to the user 104A, and associated with the financial planning component 102, as the primary account. Additionally or alternatively, the user 104A can designate a label 101A for funds in the account 101 corresponding to the goal. For instance, the account 101 can be a personal checking account belonging to the user 104A, and the user 104A can designate the label 101A for funds maintained in the account 101 corresponding to the goal. As discussed previously, access to funds having the label 101A can be limited, controlled, or otherwise restricted based on a set of access criteria. The set of access criteria can include but is not limited to permission from a subset of participating (e.g., users 104), occurrence of a predetermined event (e.g., goal satisfaction, etc.), an authorized expense, an emergency, and/or an authorized payee. For example, the user 104A may not be able to access the portion of funds maintained in the account 101 having the label 101A, unless the funds are being paid to an authorized payee (e.g., a bank issuing a mortgage).

The verification component 310 analyzes the first subset of goal data (e.g., from the interpretation component 304) and the second subset of goal data (e.g., from the info component 306), and generates, based on the analysis, a set of potential goal data. In addition, the verification component 310 prompts a user (e.g., user 104A) to select, confirm, or otherwise verify a subset of the potential goal data. Returning to the previous example, the verification component 310 can determine a set of potential goal amounts (e.g., $50,000, $25,000 and $7,500) based on down payment amounts (e.g., 20%, 10% or 3.5%) received from a set of financial institutions (e.g., using the info component 306), and can prompt the user to select one of the potential goal amounts (or enter a different goal amount). As an additional example, the verification component 310 can determine that the goal data does not include a target date, generate a set of possible target dates (e.g., based on similar users, etc.), and prompt the user 104A to select a potential target date or input a different target date. Upon verification and/or input the set of potential goal data is designated as the set of goal data.

Turning now to FIG. 4, illustrated is an example planning component 204 in accordance with various aspects described in this disclosure. As discussed, the planning component 204 establishes, creates, or otherwise generates a set of plans to achieve a goal based in part on the set of goal data (e.g., received using the goal setting component 202), and provides the set of plans to the set of participating users. For example, the planning component 204 can determine three plans to achieve a goal, and a subset of participating users 104 (users 104) can select one of the three possible plans to execute. The planning component 204 in FIG. 4 includes a participating user information component 402 (PUI component 402), an options component 404, a selector component 406, and an implementation component 408.

The PUI component 402 collects, acquires, or otherwise receives financial information related to respective participating users 104 from a set of user information sources. The financial information can include but is not limited to income, account balances, pay dates, expenses (e.g., bills, etc.), approved contribution amounts, and/or income cycles. The set of user information sources can include financial institutions (e.g., banks, etc.), social networks, and/or the participating users 104. For example, the PUI component 402 can receive information from a bank 414B associated with the second user 104B regarding direct deposit of paychecks (e.g., amounts, dates, etc.). As an additional or alternative example, the second user 104B can explicitly or implicitly provide financial information (e.g., using the input component 302). For instance, the second user 104B can input financial information in response to set of questions generated by the PUI component 402.

The options component 404 determines, creates, or otherwise generates a set of potential plans for a financial planning goal (goal). For example, the options component 404 can generate a potential plan using a calculation based approach (e.g., simple algorithm). For instance, the options component 404 can generate a plan to achieve a savings goal using the equation:

C=(A/T)/P

where C is the contribution of a participating user each time period (e.g., week, month, quarter, year, etc.), A is the goal amount, T is a quantity of time periods until a target data, and P is the quantity of participating users. For instance, if there are five participating users, the time period is weekly, the target date is four weeks away, and the goal amount is $2000, then the contribution of a participating user can be determined as $100 per week (e.g., 100=(2000/4)/5).

As an additional or alternative example, the options component 404 can generate a potential plan based at least in part on a set of dynamic plan generation criteria. The dynamic plan generation criteria can include but is not limited to the set of goal data, financial information related to respective participating users 104, and a set of predictive criteria. The predictive criteria can include but is not limited to financial data associated with similar users, plan data associated with similar goals (e.g., likelihood of success, likelihood of emergency, emergency amounts, etc.), market data (e.g., business trends, pricing trends, seasonal pay adjustments, income cycles, etc.), and/or social networking activities. For instance, the options component 404 can generate a plan that includes different contributions and/or contribution dates for respective participating users based at least in part on the set of goal data, financial data for respective users, and/or the set of dynamic plan generation criteria. It is to be appreciated that the foregoing are but a few examples of potential plans, and the subject disclosure is not limited by types or quantities of potential plans generated by the options component 404.

The selector component 406 provides for one or more participating users 104 to select and/or modify a potential plan provided via the options component 404. Returning to the previous example, a subset of the participating users 104 may find the third potential plan desirable, and can select the third potential plan without modification. Additionally or alternatively, the users 104 can adjust or modify one or more plan criteria associated with respective potential plans. The plan criteria can include but is not limited to a completion date, a goal amount, contributions of respective participating users 104, and/or contribution dates for respective participating users 104. For example, the users 104 can adjust a set of sliders corresponding to contributions of respective participating users 104, and the selector component 406 can update related plan criteria for the potential plan. For instance, adjusting a contribution amount of the first user 104A may change the goal amount and/or completion date for the potential plan.

The implementation component 408 obtains, acquires, or otherwise receives permission from a subset of the participating users 104 to implement a selected plan 412, and maintains the selected plan 412 and associated user information 414 (user info 414) in a data store 410 associated with the financial planning component 102.

FIG. 5 illustrates an example linking component 206 in accordance with various aspects described in this disclosure. As discussed, the linking component 206 associates, connects, or otherwise links different accounts to the financial planning component 102. For example, a subset of the users 104 may have unassociated accounts, and the linking component 206 links the unassociated accounts with the financial planning component 102. The linking component 206 in FIG. 5 includes a security component 502, and a formatting component 504.

The security component 502 maintains security credentials for accessing, interacting and/or communicating with respective financial institutions that are not associated with the financial planning component 102. For example, the security component 502 can maintain an identifier (e.g., username, account number, etc.) and/or password for a bank account associated with a second user 104B. As an additional or alternative example, the security component 502 can employ an account aggregation service to link unassociated accounts.

The formatting component 504 adapts, adjusts, or otherwise converts data from a first format employed by an unassociated financial institution to a second format employed by the financial planning component 102. Additionally or alternatively, the formatting component 504 can determine currency conversions. For example, the respective participating users 104 may reside (or bank) in separate countries, and their respective financial institutions may employ currencies native to the respective countries. The formatting component 504 can determine an exchange rate for the different currencies, for example, via a set of data sources (e.g., data sources 314).

FIG. 6 illustrates an example execution component 208 in accordance with various aspects described in this disclosure. As discussed, execution component 208 performs, implements, or otherwise executes a selected plan 412 (e.g., determined using the planning component 204). For example, the execution component 208 can execute deposits, withdrawals, transfers, and/or payments (e.g., accounts payable, etc.). The execution component 208 in FIG. 6 includes a tracking component 602, and an adjustment component 604.

The tracking component 602 monitors, analyses, or otherwise tracks progress with regard to completion or satisfaction of a collaborative financial goal (goal). For example, the tracking component 602 can determine a goal is Z % satisfied, where Z is a real number between 0 and 100, inclusive. The tracking component 602 includes a manual update component 606, and a data aggregation component 608 (aggregation component 608).

The manual update component 606 obtains, acquires, or otherwise receives input from a subset of the participating users 104 related to satisfaction of the goal. For example, a first user 104A can input a dollar amount saved via the manual update component 606, and the tracking component 602 can determine progress toward satisfaction of the goal based in part on the input. The input can include but is not limited to explicit user inputs (e.g., configuration selections, question/answer) such as from mouse selections, keyboard selections, speech, and so forth. Additionally or alternatively, the input can include data uploads, wherein a data upload is a transfer of data from the user or a third party source (e.g. computer or a computer readable medium), to the manual update component 606.

The aggregation component 608 obtains, acquires, or otherwise receives progress data associated with the goal from a set of data sources 314. The data aggregation component 608 can receive the progress data at predetermined times, at predetermined intervals, randomly, and/or continuously. The progress data can include but is not limited to loyalty card data, banking data, credit data, receipts (purchases, etc.), social networking activities, and/or online catalog data. For example, the data aggregation component 608 can receive loyalty card data for a participating user (e.g., user 104B), and the tracking component 602 can determine an amount of money spent by a participating user during a specified time period based in part on the loyalty card data. As discussed previously, the selected plan 412 may include individual financial plans (e.g., budget, etc.) for respective users 104, and the tracking component 602 can determine, based in part on the progress data, whether the a user 104 is satisfying a corresponding individual financial plan.

The adjustment component 604 updates, adjusts, or otherwise modifies the selected plan 412 based in part on the determined progress (e.g., determined using the tracking component 602). For example, if the set of participating users 104 are not on track to satisfy a goal by a target date, then the adjustment component 604 can modify one or more criteria for the selected plan. For instance, the adjustment component 604 can modify the target data and/or contributions of respective participating users 104. The adjustment component 604 includes a goal assessment component 610, a comparison component 612, and a calculation component 614.

The goal assessment component 610 (assessment component 610) determines, updates, or otherwise receives a set of market condition data associated with a plan. The set of market condition data can include but is not limited to availability, price, and/or rates (e.g., tax rates, interest rates, etc.). For example, a plan for purchasing a good can be determined based on a price of the good (e.g., from an online retailer) at a first time. The assessment component 610 can obtain an availability and/or price of the good at a second time after the first time. For instance, the price of the good may have decreased since the first time.

The comparison component 612 analyses, evaluates, or otherwise compares the market condition data against the selected plan 412. For example, the comparison component 612 can compare a current market price for a good against a target amount included in a selected plan 412, and determine whether the market price is less than or greater than the target amount. As an additional or alternative example, the comparison component 612 can compare current interest rates against interest rates included in a selected plan, and determine whether the target amount is sufficient based on the current interest rates.

The calculation component 614 determines, calculates, or otherwise generates a set of potential updated plans based on the comparison (e.g., by the comparison component 612). For example, if the price of a good at a second time is less than the price of the good included in a selected plan (e.g., at a first time), then the calculation component 614 can generate a set of potential updated plans having one or more updated plan criteria. For instance, the potential updated plans can include updated target dates (e.g., sooner), updated contributions for respective participating users 104 (e.g., decreased), and/or updated goals (e.g., an improved model of the good). In addition, the calculation component 614 provides for one or more participating users 104 to select and/or modify a potential updated plan. For example, a subset of the participating users 104 may find a first potential updated plan desirable, and can select the first potential updated plan. Additionally or alternatively, the subset of participating users 104 can adjust or modify one or more plan criteria associated with respective updated potential plans. The plan criteria can include but is not limited to the completion date, the goal amount, contributions of respective participating users 104, and/or contribution dates for respective participating users 104. For example, the users 104 can adjust a set of sliders corresponding to contributions of respective participating users 104, and the calculation component 614 can update related plan criteria.

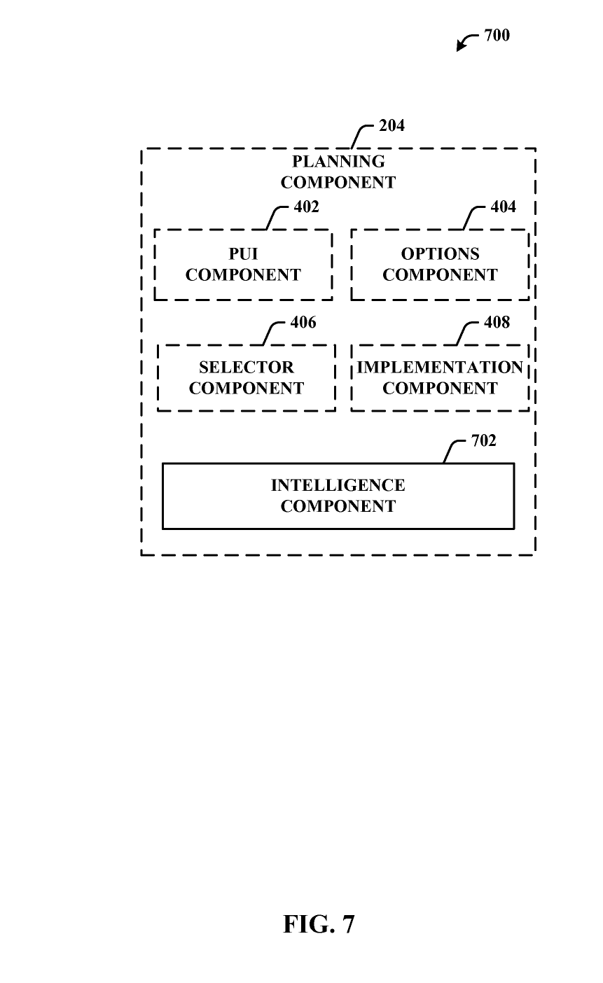

FIG. 7 illustrates an example system 700 that employs an intelligence component 702 that facilitates enhanced collaborative financial planning in accordance with various aspects described in this disclosure. For example, all or portions of the participating user information component 402 (PUI component 402), options component 404, selector component 406, and/or implementation component 408 are operatively coupled to intelligence component 702. Additionally or alternatively, all or portions of intelligence component 702 may be included in one or more components described in this disclosure. The intelligence component 702 can provide for or aid in various inferences or determinations. For example, in one implementation, the intelligence component 702 facilitates generating one or more potential plans. As discussed, the options component 404 can generate a potential plan based at least in part on a set of dynamic plan generation criteria. The set of dynamic plan generation criteria can include but is not limited to the goal data, the set of financial information related to respective participating users 104, and a set of predictive criteria. The intelligence component 702 can infer or determine dynamic plan generation criteria and/or predictive criteria.

Accordingly, in order to provide for or aid in the numerous inferences described in this disclosure, intelligence component 702 examines the entirety or a subset of the data available and provides for reasoning about or infer states of the system, environment, client, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data.

Such inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used in this disclosure also is inclusive of statistical regression that is used to develop models of priority.

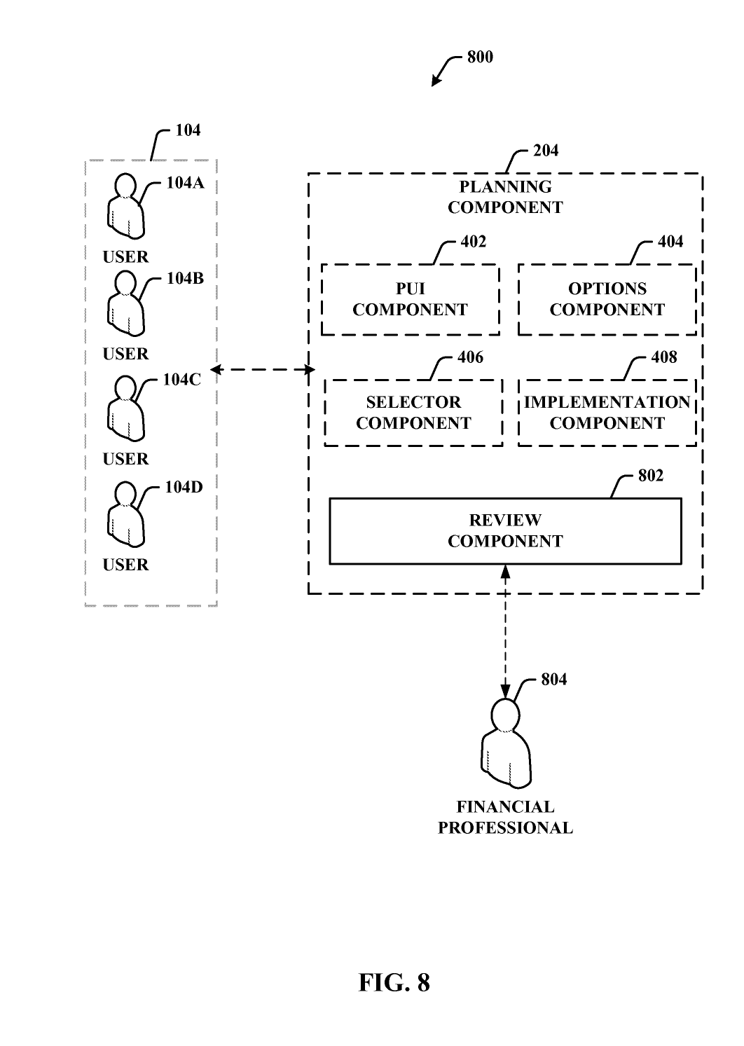

Turning now to FIG. 8, illustrated is an example planning component 204 in accordance with in various aspects described this disclosure. As discussed, the planning component 204 establishes, creates, or otherwise generates a set of plans to achieve a collaborative financial goal based in part on the set of goal data (e.g., received using the goal setting component 202), and provides the set of plans to the set of participating users 104. The planning component 204 in FIG. 8 includes a participating user information component 402 (PUI component 402), an options component 404, a selector component 406, an implementation component 408, and a review component 802.

As discussed, the PUI component 402 receives financial information related to the participating users 104 from a set of user information sources. The financial information can include but is not limited to income, account balances, pay dates, expenses (e.g., bills, etc.), approved contribution amounts, and/or income cycles. The set of user information sources can include financial institutions (e.g., banks, etc.), social networks, and/or the participating users 104. The options component 404 determines, creates, or otherwise generates a set of potential plans for a financial planning goal (goal), for example, using a calculation based approach, and/or based at least in part on a set of dynamic plan generation criteria. The dynamic plan generation criteria can include but is not limited to the goal data, the supplemental information, financial information related to respective participating users 104, and/or a set of predictive criteria. The selector component 406 provides for one or more participating users 104 to select and/or modify a potential plan provided via the options component 404. The implementation component 408 obtains, acquires, or otherwise receives permission from respective participating users 104 to implement a selected plan, and maintains the selected plan and associated user information in a data store (e.g., data store 410) associated with the financial planning component 102.

The review component 802 enables an authorized user (e.g., financial professional 804) to analyze, examine, or otherwise review plans (e.g., potential or selected) and related data. For example, the financial professional 804 can review the financial information related to the participating users 104, a subset of the potential plans, a subset of the goal data, a subset of the predictive criteria, and/or user implemented modifications. The financial professional 804 can include but is not limited to a private banker, a financial planner, an investment advisor, a market analyst, and/or an actuary. In addition, based on the review, the financial professional 804 can take one or more actions. The actions include but are not limited to approving a plan (e.g., potential or selected), rejecting a plan, and/or modifying a plan. For example, a private banker (e.g., financial professional 804) associated with a first subset of the participating users 104 can analyze a selected plan, and modify the selected plan based in part on knowledge relating to the first subset of participating users 104.

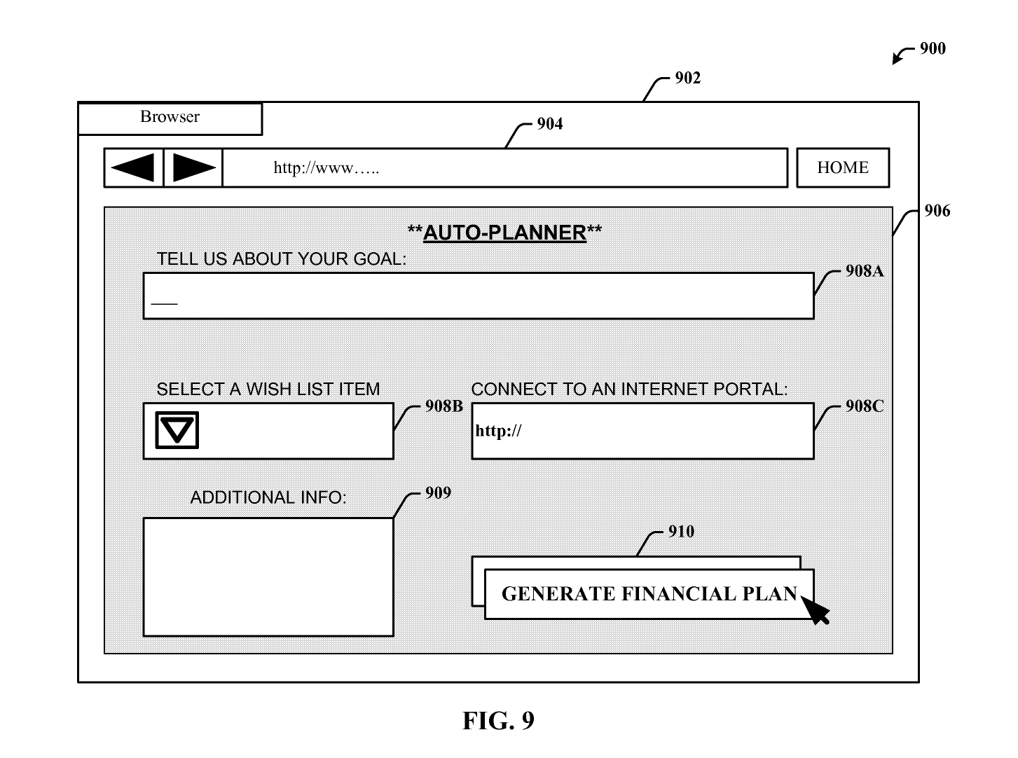

FIG. 9 illustrates an example goal setting pane 900 in accordance with various aspects described herein. As discussed previously, the financial planning component 102 can be associated with an online system (e.g., online banking system, internet shopping portal, etc.). The online system can be accessed via a web browser 902 that includes an address bar 904 (e.g., URL bar, location bar, etc.). The web browser 902 can expose a goal setting screen 906 that includes a set of goal setting input fields 908 (e.g., input fields 908A-C), and an additional input field 909.

For example, the goal setting input fields 908 can include a plain language input field 908A. The plain language input field 908A provides for a user to input goal data as human digestible data (e.g., plain language, phrases, etc.). For instance, a user can input a phrase “My wife and I would like to save a down payment for a $250,000 house” using the plain language input field 908A, and a subset of goal data including a set of participating users (e.g., user 104A and wife) and a description (e.g., house down payment) can be determined based on an analysis on the phrase (e.g., using the interpretation component 304).

As an additional or alternative example, the input fields 908 can include a wish list selection section 908B. The wish list selection section 908B provides for a user to select (e.g., via a drop down menu) one or more items maintained in a wish list. For instance, a user (e.g., user 104A) can select an item (or service) maintained in a wish list associated with a shopping portal (e.g., online catalog, etc.), and goal data including a set of participating users (e.g., the first user), and a savings objective (e.g., price of the item) can be determined based on data regarding the wish list item from the shopping portal (e.g., using the interpretation component 304).

As yet another additional or alternative example, the input fields 908 can include a portal connection section 908C. The portal connection section 908C provides for a user to connect to a different internet portal (e.g., search engine, shopping portal, financial institution, etc.), and select goal data from the different portal. For instance, a user can enter an internet address of an online travel agency in the portal connection section 908C, and select a trip package offered by the online travel agency. Goal data can be determined based on the selected trip package including but not limited to a target data, a set of participating users, and/or a goal amount. The additional input field 909 provides for a user to input goal data not included in the input fields 908. For example, the additional input field 909 can provide for a user to input a set of participating users, a set of account information, and/or a set of financial information. A plan generation selector 910 provides for a user to initiate generation of a financial plan, for example, based at last in part on goal data determined from the input fields 908 and additional input field 909.

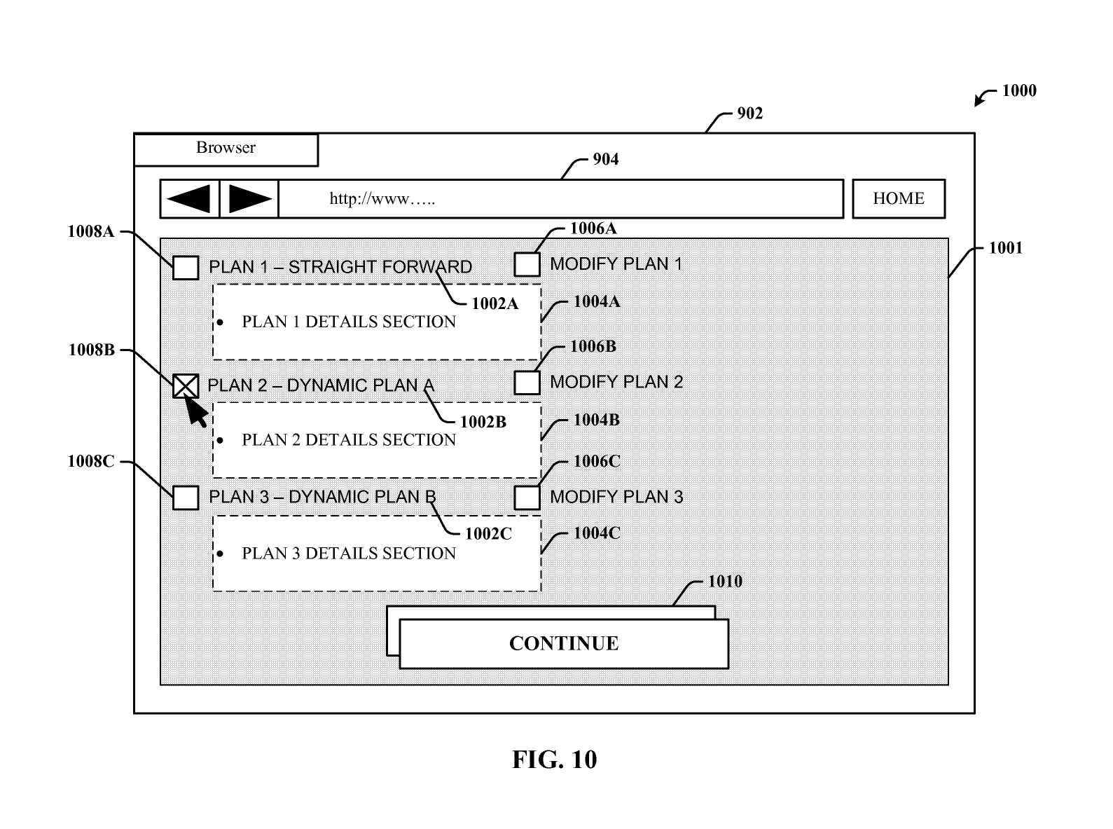

Turning now to FIG. 10, illustrated is an example plan selection pane 1000 in accordance with various aspects described herein. The plan selection pane 1000 exposes a potential plan selection screen 1001 that includes a set of potential plans 1002 (e.g., plans 1002A-C) generated (e.g., using the planning component 204) based in part on goal data (e.g., received via the goal setting pane 900). For example, the plans 1002 can include a first plan 1002A generated using a calculation based approach (e.g., straightforward plan) (discussed in greater detail with reference to FIG. 4). Additionally or alternatively, the plans 1002 can include a set of generated potential plans (e.g., 1002B-1002C). As discussed, potential plans can be generated (e.g., using the options component 404) based at least in part on a set of dynamic plan generation criteria. The dynamic plan generation criteria can include but is not limited to the goal data, the supplemental information, financial information related to respective participating users, and a set of predictive criteria. The predictive criteria can include but is not limited to financial data associated with similar users, plan data associated with similar goals (e.g., likelihood of success, likelihood of emergency, emergency amounts, etc.), market data (e.g., business trends, pricing trends, seasonal pay adjustments, income cycles, etc.), and/or social networking activities.

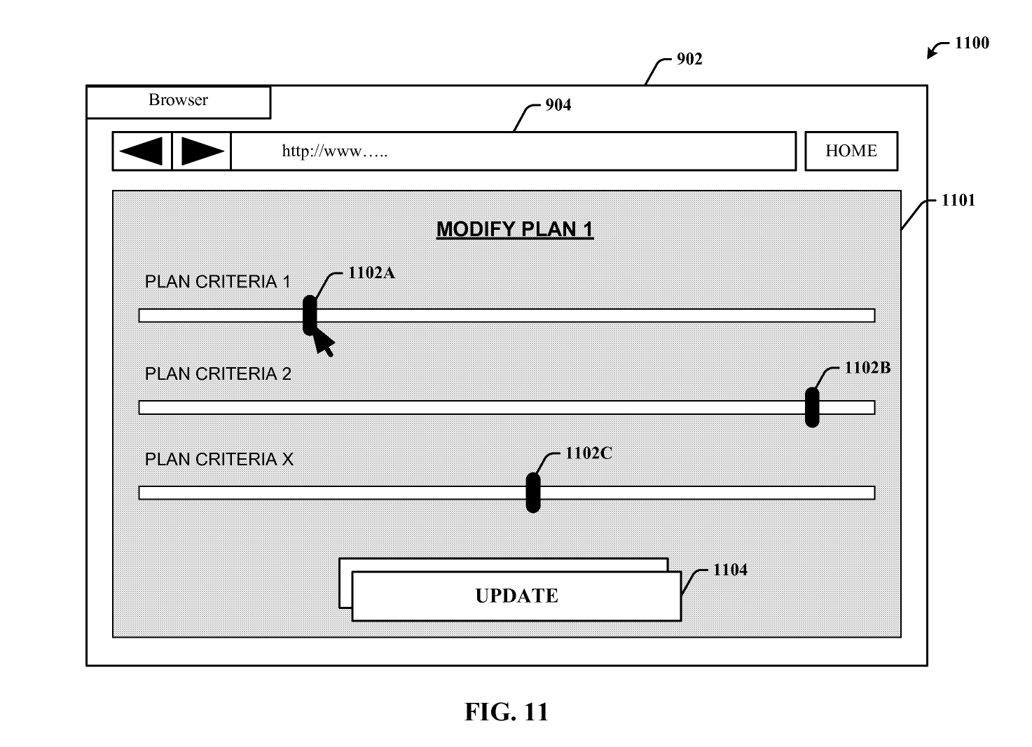

In addition, plan selection screen 1001 can expose a set of potential plan details sections 1004 (e.g., sections 1004A-1004C) corresponding to respective potential plans 1002. The potential plan details sections 1004 can include information regarding the respective plan including but is not limited to goal data (e.g., goal amount, target date, description, a set of participating users, etc.), contributions of respective participating users, and/or contribution dates for respective participating users. A set of selection fields 1006 provide for a user to select a corresponding plan 1002. For example, a user can select second potential plan 1008B via a second selection field 1006B. Additionally or alternatively, a set of modification fields 1008 provide for a user to modify a corresponding plan 1002 (discussed in greater detail with reference to FIGS. 4 and 11). A continue button 1010 provides for a user to initiate execution of a selection (e.g., selection fields 1006 or modification fields 1008). For example, if a user selects a second plan 1002B, then the continue button 1010 can initiate implementation of the second plan 1002B.

FIG. 11 illustrates an example potential plan modification pane 1100 in accordance with various aspects described herein. The potential plan modification pane 1100 exposes a potential plan modification screen 1101 that includes a set of adjusters 1102 (e.g., sliders 1102A-C) that correspond to respective plan criteria. A user can adjust, update, or otherwise modify a subset of plan criteria using corresponding adjusters 1102. For example, a first plan criteria can include a contribution amount for a first user, and the user can modify the contribution amount by changing a value of an adjuster 1102A corresponding to the contribution amount. An update button 1104 provides for the user to initiate implementation of modifications. It is to be appreciated that the potential plan modification pane 1100 can include virtually any quantity of adjusters 1102. In addition, it is to be appreciated that although the adjusters 1102 are illustrated as being sliders, such implementation is not so limited. For example, the adjusters 1100 can include but are not limited to input fields (e.g., text, numbers, etc.), radio knobs, lists, and/or drop down menus.

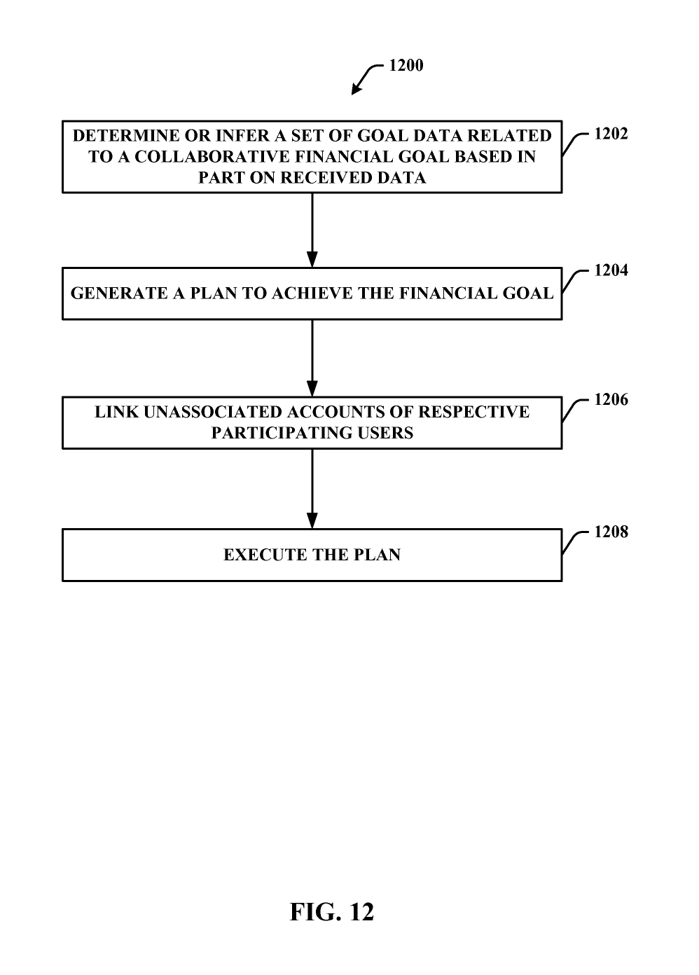

In view of the example systems described supra, methods that may be implemented in accordance with the described subject matter may be better appreciated with reference to the flow charts of FIGS. 12-15. While for purposes of simplicity of explanation, the methods are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 12, illustrated is an example methodology for collaborative financial planning 1200 in accordance with aspects described herein. Methodology 1200 can begin at block 1202, wherein a set of goal data for a collaborative financial goal (goal data) is determined or inferred based in part on received data relating to a collaborative financial goal and/or a subset of participating users. The goal data can include but is not limited to a savings and/or investment objective (goal amount), a set of participating users (participating users or users), a goal reason and/or description (description), and/or a target completion date (target date). For example, a set of data related to a collaborative financial goal can be received from a primary user (e.g., user 104A) or subset of the participating users via a financial planning tool (e.g., financial planning component 102), and the goal data can be determined or inferred based in part on the received data (discussed in greater detail with reference to FIG. 3).

At 1204, a plan to achieve the collaborative financial goal is generated based at least in part on the set of goal data. Generating the plan can include generating the plan via a calculation based approach, and/or a generating the plan (discussed in greater detail with reference to FIG. 4). The plan can include but is not limited to individual financial plans (e.g., budget, etc.) for respective participating users, contributions of respective users, and/or contribution dates of respective participating users. For instance, the plan can include a first contribution amount and a first set of contribution dates for a first participating user, and a second contribution amount and a second set of contribution dates for a second participating user.

At 1206, unassociated financial intuitions (e.g., banks, etc.) and/or accounts for respective participating users are connected, associated, or otherwise linked. For example, a subset of the participating users may have accounts that are not associated with a financial planning tool (e.g., financial planning component 102), and the accounts can be linked to the financial planning tool (e.g., using the linking component 206). Linking the unassociated accounts can facilitate communications, transactions, and/or reporting with different financial institutions and/or accounts (discussed in greater detail with reference to FIG. 5).

At 1208, the plan is performed, implemented, or otherwise executed. For example, deposits, withdrawals, transfers, purchases, and/or payments (e.g., accounts payable, etc.) can be executed based on the plan. For instance, based on the selected plan, automatic funds transfers can be carried out, and/or reminders (e.g., progress reminders, contribution reminders, contribution date reminders, etc.) can be provided to participating users. Additionally, progress regarding completion of the collaborative financial goal can be analyzed, tracked, or otherwise monitored, and the plan can be adjusted or updated based on the progress (discussed in greater detail with reference to FIG. 6).

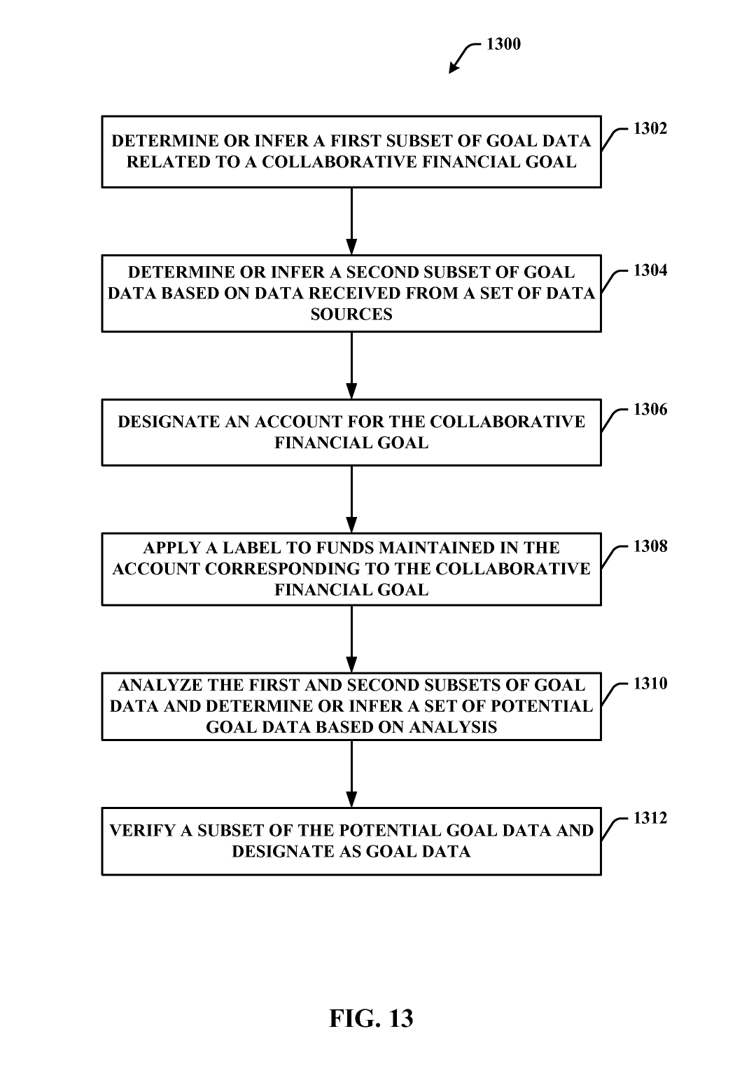

Referring to FIG. 13, illustrated is an example methodology for collaborative financial planning 1300 in accordance with aspects described herein. Methodology 1300 can begin at block 1302, wherein a first subset of data related to a collaborative financial goal (goal data) is determined or inferred. The first subset of goal data can include but is not limited to a savings and/or investment objective (goal amount), a set of participating users (participating users or users), a goal reason and/or description (description), and/or a target completion date (target date). For example, the first subset of goal data can be determined or inferred based at least in part on data received from a subset of the participating users, an online catalog, a financial institution, a website, a search engine, and/or an account (e.g., bank, investment account, etc.) associated with one or more of the participating users. Additionally or alternatively, the first subset of goal data can be determined or inferred based in part on input received from a subset of the participating users, a financial institution, and/or a set of data sources. For example, human digestible data (e.g., plain language, phrases, etc.) provided by a user can be analyzed, and based on the analysis, the first subset of the goal data can be determined or inferred. As another additional or alternative example, the goal data can be determined or inferred based on one or more items maintained in a wish list (e.g., favorites list, shopping cart, etc.).

At 1304, a second subset of goal data (e.g., supplemental information) can be determined or inferred based on data received from a set of data sources. The supplemental information includes but is not limited to goal data not included in the first subset of goal data. For example, a second subset of goal data for a mortgage can include but is not limited to current or typical mortgage interest rates and/or down payment amounts (e.g., percentages). The set of data sources can include but are not limited to financial intuitions, websites, databases, social networks, search engines, and/or online retailers (e.g., catalogs).

At 1306, a subset of the users (e.g., a primary user) designate an account for maintaining funds related to the goal (primary account). For example, a first participating user can designate an account belonging to the first participating user as the primary account. Alternatively, the participants may keep the funds in own accounts. Alternatively, labels could be applied to their own accounts. Alternatively, the labels could prevent users from accessing designated funds without other participants consent or permission. This could be done through configuration settings of each account holder, as described above. At 1308, a subset of the participating users can designate a label for funds in the account corresponding to the goal. For instance, the account can be a personal checking account belonging to the first participating user, and the first participating user may designate the label (e.g., down payment, etc.) for funds maintained in the personal checking account corresponding to the goal. As discussed previously, access to funds having the label can be limited, controlled, or otherwise restricted based on a set of access criteria. The access criteria can include but is not limited to permission from a subset of the participating users, occurrence of a predetermined event (e.g., goal satisfaction, etc.), an authorized expense, an emergency, and/or an authorized payee.

At 1310, the first subset of goal data and the second subset of goal data are analyzed, and a set of potential goal data is determined based on the analysis. At 1312, a subset of the potential data is verified and designated as the goal data. For example, a user can be prompted to verify a subset of the potential goal data. For instance, a set of potential goal amounts (e.g., $50,000, $25,000 and $7,500) can be determined based on down payment amounts (e.g., 20%, 10% or 3.5%) received from a set of financial institutions, and the user can be prompted to select one of the potential goal amounts (or enter a different goal amount).

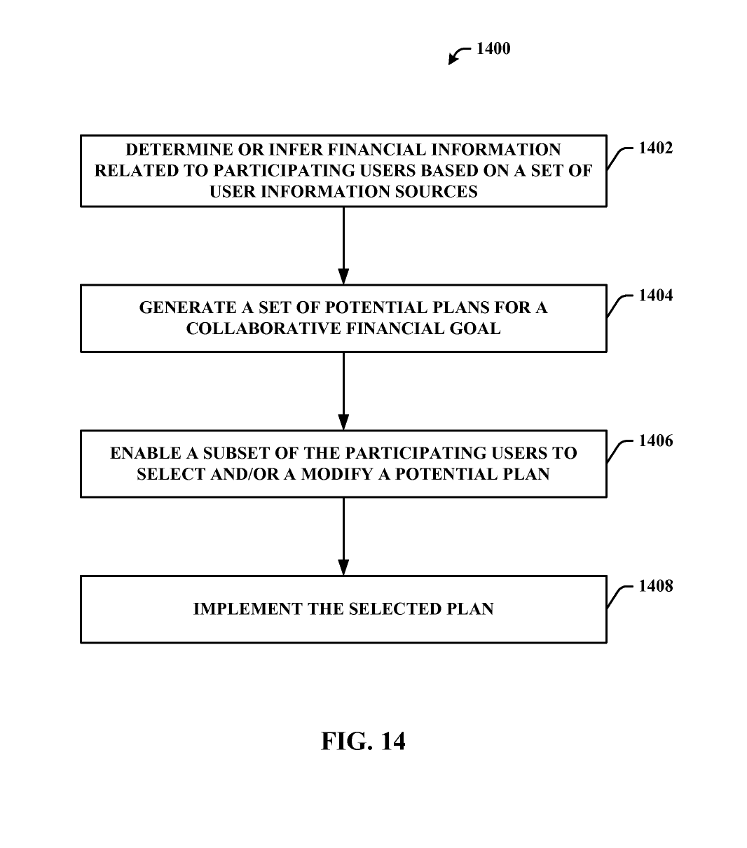

FIG. 14 illustrates an example methodology for collaborative financial planning 1400 in accordance with aspects described herein. Methodology 1400 can begin at block 1402, wherein financial information related to a set of users participating in a collaborative financial goal (participating users or users) is determined or inferred based on a set of user information sources. The financial information can include but is not limited to income, account balances, pay dates, expenses (e.g., bills, etc.), approved contribution amounts, and/or income cycles. The set of user information sources can include financial institutions (e.g., banks, etc.), social networks, and/or the participating users 104. For example, the financial information regarding direct deposit of paychecks for a participating user (e.g., amounts, dates, etc.) can be received from a bank associated with the participating user. As an additional or alternative example, the participating user can explicitly or implicitly provide the financial information. For instance, the user can input the financial information in response to set of questions.

At 1404, a set of potential plans for a collaborative financial goal are generated based at least in part on a set of goal data and the financial information related to respective participating users. For example, the potential plan is generated using a calculation based approach (e.g., simple algorithm). For instance, a potential plan can be generated using the equation:

C=(A/T)/P

where C is the contribution of a participating user each time period (e.g., week, month, quarter, year, etc.), A is the goal amount, T is a quantity of time periods until a target data, and P is the quantity of participating users. As an additional or alternative example, the potential plan is generated based at least in part on a set of dynamic plan generation criteria. The dynamic plan generation criteria can include but is not limited to the goal data, financial information related to respective participating users 104, and a set of predictive criteria. The predictive criteria can include but is not limited to financial data associated with similar users, data associated with similar goals (e.g., likelihood of success, likelihood of emergency, emergency amounts, etc.), market data (e.g., business trends, pricing trends, seasonal pay adjustments, income cycles, etc.), and/or social networking activities.

At 1406, a subset of the participating users are enabled to select and/or modify a potential plan. For example, a subset of the participating users 104 may find a third potential plan desirable, and can select the third potential plan without modification. Additionally or alternatively, the users can adjust or modify one or more plan criteria associated with respective potential plans. The plan criteria can include but is not limited to the completion date, the goal amount, contributions of respective participating users, and/or contribution dates for respective participating users. For example, the users can adjust a set of sliders corresponding to contributions of respective participating users, and the selector component 406 can update related plan criteria for the potential plan. For instance, adjusting a contribution amount of a first user may change the goal amount and/or completion date for the potential plan. At 1408, permission is received from respective participating users to implement a selected plan, and the selected plan and associated user information are maintained in a data store.

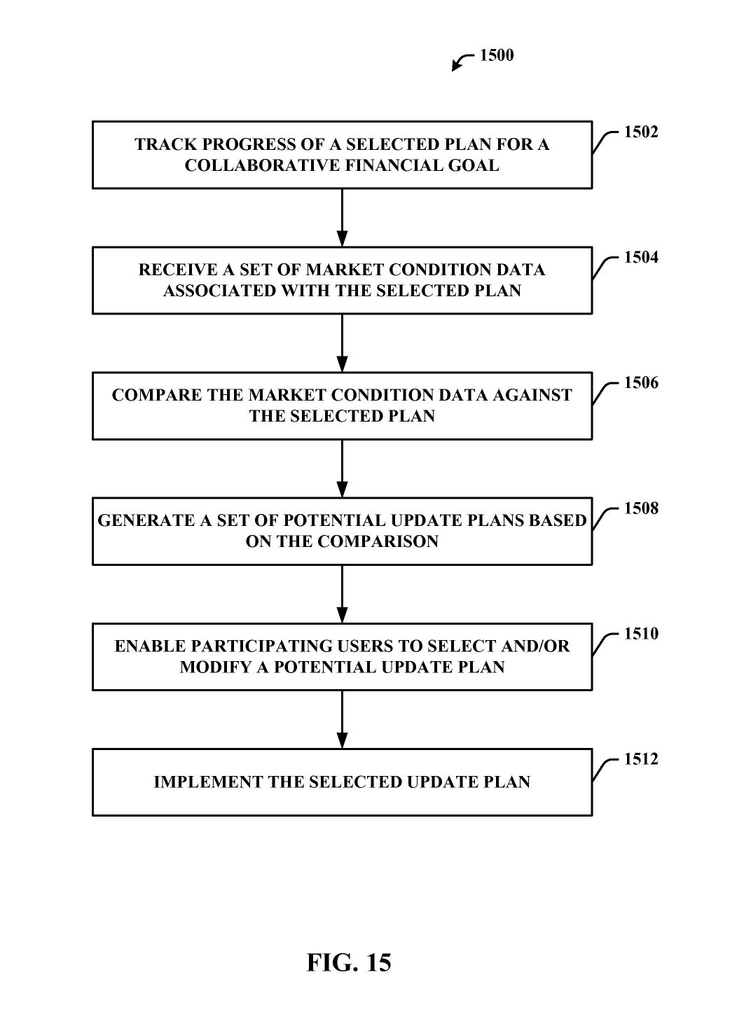

FIG. 15 illustrates an example methodology for collaborative financial planning 1500 in accordance with aspects described herein. Methodology 1500 can begin at block 1502, wherein progress of a selected plan for a collaborative financial goal is tracked. For example, participating users can input data relating to satisfaction of a goal. As an additional or alternative example, progress data associated with a goal can be received from a set of data sources. The progress data can include but is not limited to loyalty card data, banking data, credit data, receipts (purchases, etc.), social networking activities, and/or online catalog data. As discussed previously, a selected plan may include individual financial plans (e.g., budget, etc.) for respective participating users, and it can be determined, based in part on the progress data, whether the a user is satisfying a corresponding individual financial plan.

At 1504, a set of market condition data associated with a plan is received. The set of market condition data can include but is not limited to availability, price, and/or rates (e.g., tax rates, interest rates, etc.). For example, a plan for purchasing a good can be determined based on a price of the good (e.g., from an online retailer) at a first time, and an availability and/or price of the good can be determined at a second time after the first time. For instance, the price of the good may have decreased since the first time, or the good may no longer be available.

At 1506, the market condition data is compared against the selected plan. For example, a current market price for a good can be compared against a target amount included in a selected plan, and it can be determined whether the market price is less than or greater than the target amount. At 1508, a set of potential updated plans are generated based in part on the comparison. For example, if the price of a good at a second time is less than the price of the good included in a selected plan (e.g., at a first time), then a set of potential updated plans incorporating the lower price can be generated.

At 1510, one or more participating users are enabled to select and/or modify a potential updated plan. For example, a subset of the participating users may find a first potential updated plan desirable, and can select the first potential updated plan. Additionally or alternatively, the users can adjust or modify one or more plan criteria associated with respective updated potential plans. The plan criteria can include but is not limited to a completion date, a goal amount, contributions of respective participating users, and/or contribution dates for respective participating users. For example, the users can adjust a set of sliders corresponding to contributions of respective participating users, and the calculation component can update related plan criteria (e.g., target date, goal amount, etc.). At 1512, permission is received from a subset of the participating users to implement a selected update plan, and the selected update plan and associated user information are maintained in a data store.

### Exemplary Networked and Distributed Environments

One of ordinary skill in the art can appreciate that the various non-limiting embodiments of the collaborative financial planning systems and methods described herein can be implemented in connection with any computer or other client or server device, which can be deployed as part of a computer network or in a distributed computing environment, and can be connected to any kind of data store. In this regard, the various non-limiting embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the shared shopping mechanisms as described for various non-limiting embodiments of the subject disclosure.

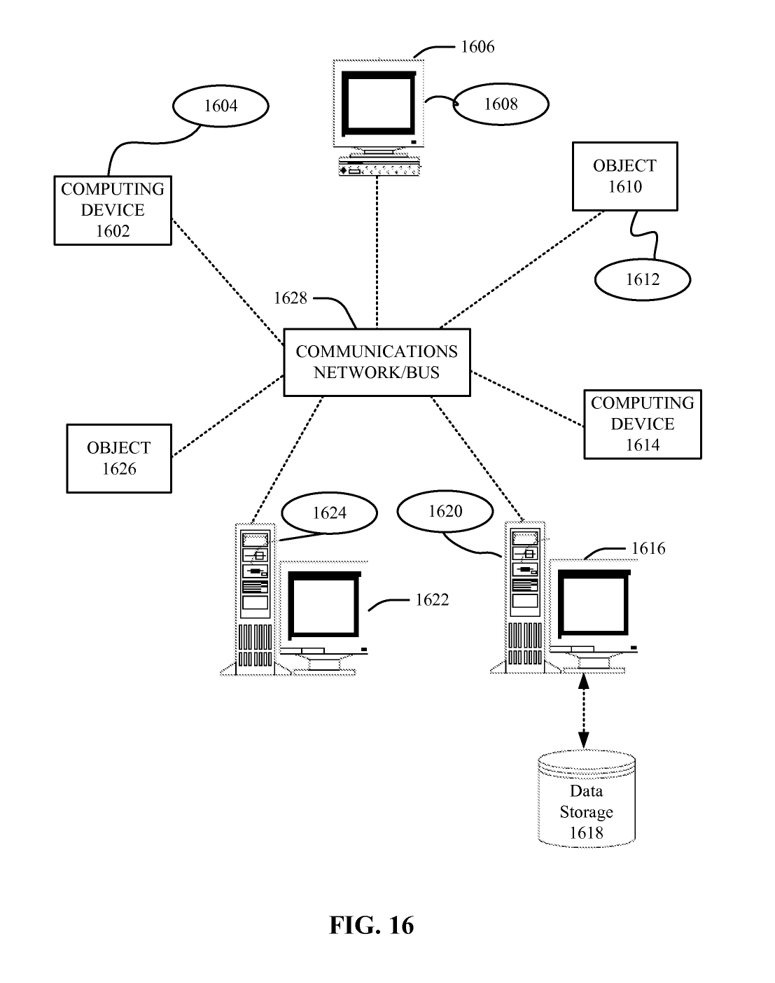

FIG. 16 provides a schematic diagram of an exemplary networked or distributed computing environment. The distributed computing environment comprises computing objects 1610, 1612, etc. and computing objects or devices 1620, 1622, 1624, 1626, 1628, etc., which may include programs, methods, data stores, programmable logic, etc., as represented by applications 1630, 1632, 1634, 1636, 1638. It can be appreciated that computing objects 1610, 1612, etc. and computing objects or devices 1620, 1622, 1624, 1626, 1628, etc. may comprise different devices, such as personal digital assistants (PDAs), audio/video devices, mobile phones, MP3 players, personal computers, laptops, etc.

Each computing object 1610, 1612, etc. and computing objects or devices 1620, 1622, 1624, 1626, 1628, etc. can communicate with one or more other computing objects 1610, 1612, etc. and computing objects or devices 1620, 1622, 1624, 1626, 1628, etc. by way of the communications network 1640, either directly or indirectly. Even though illustrated as a single element in FIG. 16, communications network 1640 may comprise other computing objects and computing devices that provide services to the system of FIG. 16, and/or may represent multiple interconnected networks, which are not shown. Each computing object 1610, 1612, etc. or computing object or device 1620, 1622, 1624, 1626, 1628, etc. can also contain an application, such as applications 1630, 1632, 1634, 1636, 1638, that might make use of an API, or other object, software, firmware and/or hardware, suitable for communication with or implementation of the shared shopping systems provided in accordance with various non-limiting embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the shared shopping systems as described in various non-limiting embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In client/server architecture, particularly a networked system, a client is usually a computer that accesses shared network resources provided by another computer, e.g., a server. In the illustration of FIG. 16, as a non-limiting example, computing objects or devices 1620, 1622, 1624, 1626, 1628, etc. can be thought of as clients and computing objects 1610, 1612, etc. can be thought of as servers where computing objects 1610, 1612, etc., acting as servers provide data services, such as receiving data from client computing objects or devices 1620, 1622, 1624, 1626, 1628, etc., storing of data, processing of data, transmitting data to client computing objects or devices 1620, 1622, 1624, 1626, 1628, etc., although any computer can be considered a client, a server, or both, depending on the circumstances. Any of these computing devices may be processing data, or requesting services or tasks that may implicate the shared shopping techniques as described herein for one or more non-limiting embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1640 or bus is the Internet, for example, the computing objects 1610, 1612, etc. can be Web servers with which other computing objects or devices 1620, 1622, 1624, 1626, 1628, etc. communicate via any of a number of known protocols, such as the hypertext transfer protocol (HTTP). Computing objects 1610, 1612, etc. acting as servers may also serve as clients, e.g., computing objects or devices 1620, 1622, 1624, 1626, 1628, etc., as may be characteristic of a distributed computing environment.

### Exemplary Computing Device

As mentioned, advantageously, the techniques described herein can be applied to any device where it is desirable to facilitate shared shopping. It is to be understood, therefore, that handheld, portable and other computing devices and computing objects of all kinds are contemplated for use in connection with the various non-limiting embodiments, i.e., anywhere that a device may wish to engage in a shopping experience on behalf of a user or set of users. Accordingly, the below general purpose remote computer described below in FIG. 17 is but one example of a computing device.

Although not required, non-limiting embodiments can partly be implemented via an operating system, for use by a developer of services for a device or object, and/or included within application software that operates to perform one or more functional aspects of the various non-limiting embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is to be considered limiting.

FIG. 17 thus illustrates an example of a suitable computing system environment 1700 in which one or aspects of the non-limiting embodiments described herein can be implemented, although as made clear above, the computing system environment 1700 is only one example of a suitable computing environment and is not intended to suggest any limitation as to scope of use or functionality. Neither should the computing system environment 1700 be interpreted as having any dependency or requirement relating to any one or combination of components illustrated in the exemplary computing system environment 1700.

With reference to FIG. 17, an exemplary remote device for implementing one or more non-limiting embodiments includes a general purpose computing device in the form of a computer 1710. Components of computer 1710 may include, but are not limited to, a processing unit 1720, a system memory 1730, and a system bus 1722 that couples various system components including the system memory to the processing unit 1720.

Computer 1710 typically includes a variety of computer readable media and can be any available media that can be accessed by computer 1710. The system memory 1730 may include computer storage media in the form of volatile and/or nonvolatile memory such as read only memory (ROM) and/or random access memory (RAM). Computer readable media can also include, but is not limited to, magnetic storage devices (e.g., hard disk, floppy disk, magnetic strip), optical disks (e.g., compact disk (CD), digital versatile disk (DVD)), smart cards, and/or flash memory devices (e.g., card, stick, key drive). By way of example, and not limitation, system memory 1730 may also include an operating system, application programs, other program modules, and program data.

A user can enter commands and information into the computer 1710 through input devices 1740. A monitor or other type of display device is also connected to the system bus 1722 via an interface, such as output interface 1750. In addition to a monitor, computers can also include other peripheral output devices such as speakers and a printer, which may be connected through output interface 1750.

The computer 1710 may operate in a networked or distributed environment using logical connections to one or more other remote computers, such as remote computer 1770. The remote computer 1770 may be a personal computer, a server, a router, a network PC, a peer device or other common network node, or any other remote media consumption or transmission device, and may include any or all of the elements described above relative to the computer 1710. The logical connections depicted in FIG. 17 include a network 1772, such local area network (LAN) or a wide area network (WAN), but may also include other networks/buses. Such networking environments are commonplace in homes, offices, enterprise-wide computer networks, intranets and the Internet.

As mentioned above, while exemplary non-limiting embodiments have been described in connection with various computing devices and network architectures, the underlying concepts may be applied to any network system and any computing device or system.

Also, there are multiple ways to implement the same or similar functionality, e.g., an appropriate application programming interface (API), tool kit, driver source code, operating system, control, standalone or downloadable software object, etc. which enables applications and services to take advantage of techniques provided herein. Thus, non-limiting embodiments herein are contemplated from the standpoint of an API (or other software object), as well as from a software or hardware object that implements one or more aspects of the shared shopping techniques described herein. Thus, various non-limiting embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it is to be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various non-limiting embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

As discussed herein, the various embodiments disclosed herein may involve a number of functions to be performed by a computer processor, such as a microprocessor. The microprocessor may be a specialized or dedicated microprocessor that is configured to perform particular tasks according to one or more embodiments, by executing machine-readable software code that defines the particular tasks embodied by one or more embodiments. The microprocessor may also be configured to operate and communicate with other devices such as direct memory access modules, memory storage devices, Internet-related hardware, and other devices that relate to the transmission of data in accordance with one or more embodiments. The software code may be configured using software formats such as Java, C++, XML (Extensible Mark-up Language) and other languages that may be used to define functions that relate to operations of devices required to carry out the functional operations related to one or more embodiments. The code may be written in different forms and styles, many of which are known to those skilled in the art. Different code formats, code configurations, styles and forms of software programs and other means of configuring code to define the operations of a microprocessor will not depart from the spirit and scope of the various embodiments.

Within the different types of devices, such as laptop or desktop computers, hand held devices with processors or processing logic, and also possibly computer servers or other devices that utilize one or more embodiments, there exist different types of memory devices for storing and retrieving information while performing functions according to the various embodiments. Cache memory devices are often included in such computers for use by the central processing unit as a convenient storage location for information that is frequently stored and retrieved. Similarly, a persistent memory is also frequently used with such computers for maintaining information that is frequently retrieved by the central processing unit, but that is not often altered within the persistent memory, unlike the cache memory. Main memory is also usually included for storing and retrieving larger amounts of information such as data and software applications configured to perform functions according to one or more embodiments when executed, or in response to execution, by the central processing unit. These memory devices may be configured as random access memory (RAM), static random access memory (SRAM), dynamic random access memory (DRAM), flash memory, and other memory storage devices that may be accessed by a central processing unit to store and retrieve information. During data storage and retrieval operations, these memory devices are transformed to have different states, such as different electrical charges, different magnetic polarity, and the like. Thus, systems and methods configured according to one or more embodiments as described herein enable the physical transformation of these memory devices. Accordingly, one or more embodiments as described herein are directed to novel and useful systems and methods that, in the various embodiments, are able to transform the memory device into a different state when storing information. The various embodiments are not limited to any particular type of memory device, or any commonly used protocol for storing and retrieving information to and from these memory devices, respectively.

Embodiments of the systems and methods described herein facilitate the management of data input/output operations. Additionally, some embodiments may be used in conjunction with one or more conventional data management systems and methods, or conventional virtualized systems. For example, one embodiment may be used as an improvement of existing data management systems.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

Although some specific embodiments have been described and illustrated as part of the disclosure of one or more embodiments herein, such embodiments are not to be limited to the specific forms or arrangements of parts so described and illustrated. The scope of the various embodiments are to be defined by the claims appended hereto and their equivalents.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium.

Computing devices typically include a variety of media, which can include computer-readable storage media and/or communications media, which two terms are used herein differently from one another as follows. Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other. As used herein, unless explicitly or implicitly indicating otherwise, the term “set” is defined as a non-zero set. Thus, for instance, “a set of criteria” or “a set of criterion” can include one criterion, or many criteria.

A number of embodiments have been described. Nevertheless, it will be understood that various modifications may be made without departing from the spirit and scope of the disclosure.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims and their equivalents.

1. A system, comprising:
a memory storing computer-executable instructions; and
a processor, communicatively coupled to the memory, which executes, or facilitates execution of the computer-executable instructions to at least:
receive contextual data related to a set of participating users;
determine a collaborative financial goal for the set of participating users based on the contextual data;
generate plan data representing a plan to achieve the collaborative financial goal; and
execute the plan for the collaborative financial goal.

2. The system of claim 1, wherein the processor further executes or facilitates the execution of the computer-executable instructions to receive a set of data related to the collaborative financial goal from at least one of a subset of the participating users, or at least one data source.

3. The system of claim 2, wherein the at least one data source includes a financial institution, a website, a database, a social network, a search engine, or a shopping portal.

4. The system of claim 1, wherein the processor further executes or facilitates the execution of the computer-executable instructions to determine respective sets of financial information for a subset of the participating users, wherein the plan data is generated based at least in part on the respective sets of financial information.

5. The system of claim 1, wherein the processor further executes or facilitates execution of the computer-executable instructions to generate additional plan data representing a set of potential plans to achieve the collaborative financial goal, and enable a subset of the participating users to at least one of select at least one potential plan in the set of potential plans, or modify at least one potential plan in the set of potential plans.

6. The system of claim 1, wherein the processor further executes or facilitates execution of the computer-executable instructions to enable a subset of the participating users to designate an account to maintain funds corresponding to the collaborative financial goal.

7. The system of claim 6, wherein the processor further executes or facilitates execution of the computer-executable instructions to enable the subset of the participating users to designate a label for funds maintained in the account corresponding to the collaborative financial goal.

8. The system of claim 7, wherein the label designates restricted access to funds corresponding to the collaborative financial goal based on a set of access criteria.

9. The system of claim 8, wherein the set of access criteria includes at least one of permission from at least one participating user, occurrence of a predetermined event, an authorized expense, an emergency, or an authorized payee.

10. The system of claim 6, wherein the processor further executes or facilitates execution of the computer-executable instructions to transfer funds from respective accounts for a subset of the participating users to the account.

11. The system of claim 10, wherein the processor further executes or facilitates execution of the computer-executable instructions to facilitate communication with at least one of unassociated accounts or unassociated financial institutions.

12. The system of claim 1, wherein the processor further executes or facilitates execution of the computer-executable instructions to monitor progress with regard to completion of the collaborative financial goal.

13. The system of claim 12, wherein the processor further executes or facilitates execution of the computer-executable instructions to update the plan based at least in part on the progress.

14. The system of claim 13, wherein the processor further executes or facilitates execution of the computer-executable instructions to update the plan based at least in part on a set of market condition data, wherein the set of market condition data includes at least one of an availability, a price, or a rate related to the collaborative financial goal.

15. A method, comprising:
receiving, by a system including a processor, contextual data associated with a collaborative financial goal for a set of users;
determining a set of goal data for a collaborative financial goal based at least in part on an analysis of the contextual data;
generating, by the system, plan data representing a plan for the collaborative financial goal based at least in part on the set of goal data; and
in response to the generating, executing, by the system, the plan to achieve the collaborative financial goal.

16. The method of claim 15, wherein the receiving the contextual data relating to the collaborative financial goal includes receiving the data from at least one of a subset of the users, a financial intuition, a website, a database, a social network, a search engine, or a shopping portal.

17. The method of claim 15, further comprising enabling, by the system, a subset of the users to designate at least one of an account or label to maintain funds corresponding to the collaborative financial goal.

18. The method of claim 17, wherein designating the label includes restricting access to the funds corresponding to the collaborative financial goal based at least in part on at least one of permission from at least one user, occurrence of a predetermined event, an authorized expense, an emergency, or an authorized payee.

19. The method of claim 17, wherein the executing the plan to achieve the collaborative financial goal includes transferring funds from an account of at least one user in the set of users to at least one of the account or the label.

20. The method of claim 15, further comprising determining, by the system, at least one of a progress with regard to completion of the collaborative financial goal, or a set of market condition data.

21. The method of claim 20, further comprising modifying, by the system, the plan based at least in part on at least one of the progress, or the set of market condition data.

22. The method of claim 20, wherein the determining the set or market condition data includes determining or inferring at least one of an availability, a price, or a rate related to the collaborative financial goal.

23. The method of claim 15, wherein the generating the plan data includes at least one of generating the plan using a calculation based approach, or generating the plan based at least in part on the set of goal data, a set of financial information related to respective users, or a set of predictive criteria.

24. A non-transitory computer readable storage medium comprising computer executable instructions that, in response to execution, cause a computing system including a processor to perform operations, comprising:
receiving contextual data associated with a collaborative financial goal for a set of users;
or inferring a set of goal data for a collaborative financial goal based at least in part on the contextual data relating to the collaborative financial goal;
generating plan data representing a plan for the collaborative financial goal based at least in part on the set of goal data; and
executing the plan to achieve the collaborative financial goal.

25. The non-transitory computer readable storage medium of claim 24, wherein the receiving the contextual data relating to the collaborative financial goal, includes receiving the data from at least one of a subset of the users, a financial intuition, a website, a database, a social network, a search engine, or a shopping portal.

26. The non-transitory computer readable storage medium of claim 24, wherein the operations further comprise enabling a subset of the users to designate at least one of an account or label to maintain funds corresponding to the collaborative financial goal.

27. The non-transitory computer readable storage medium of claim 26, wherein the operations further comprise restricting access to the funds corresponding to the collaborative financial goal based at least in part on at least one of permission from a subset of participating, occurrence of a predetermined event, an authorized expense, an emergency, or an authorized payee.

28. The non-transitory computer readable storage medium of claim 26, wherein the executing the plan to achieve the collaborative financial goal, includes transferring funds from an account of at least one user in the set of users to at least one of the account or the label.

29. The non-transitory computer readable storage medium of claim 24, wherein the operations further comprise determining or inferring at least one of progress with regard to completion of the collaborative financial goal, or a set of market condition data.

30. The non-transitory computer readable storage medium of claim 29, wherein the operations further comprise modifying the plan based at least in part on at least one of the progress, or the set of market condition data.

31. The non-transitory computer readable storage medium of claim 29, wherein the determining or inferring the set or market condition data includes determining or inferring at least one of an availability, a price, or a rate related to the collaborative financial goal.

32. The non-transitory computer readable storage medium of claim 24, wherein the generating the plan includes at least one of generating the plan using a calculation based approach, or generating the plan based at least in part on the set of goal data, a set of financial information related to respective users, or a set of predictive criteria.
